(19) United States
(12) Patent Application Publication
(10) Pub. No.: US 2026/0150826 A1
(43) Pub. Date: Jun. 4, 2026

(54) SPINNING REEL

(71) Applicant: Shimano Inc., Osaka (JP)

(72) Inventor: Atsushi KAWAMATA, Osaka (JP)

(21) Appl. No.: 19/354,634

(22) Filed: Oct. 9, 2025

(30) Foreign Application Priority Data
Dec. 4, 2024 (JP) 2024-211758

(51) Int. Cl. A01K 89/06

(52) U.S. Cl. CPC A01K 89/06

(57) ABSTRACT

A spinning reel includes a spool, a rotor, a bail arm, a moving member, detected part, and a detected part. The bail arm pivots between a first posture in which a fishing line can be wound onto the spool by rotation of the rotor, and a second posture in which the fishing line is released from the spool. The moving member is at a first position when the bail arm is in the first posture, is positioned at a second position when the bail arm is in the second posture, and returns the bail arm from the second posture of the bail arm to the first posture of the bail arm by shifting from the second position to the first position. The detected part is on the moving member, and the first detecting part is on the reel body and detects a position of the detected part.

### CROSS-REFERENCE TO RELATED APPLICATIONS

This application claims priority to Japanese Patent Application No. 2024-211758, filed on December 4, 2024.The entire disclosure of Japanese Patent Application No. 2024-211758 is hereby incorporated by reference.

### BACKGROUND

### Technical Field

The present disclosure generally relates to the structure of a spinning reel used for fishing.

### Background Information

When using a spinning reel while fishing, an angler generally opens the bail, casts the tackle, such as a lure, closes the bail, and winds the tackle that was cast. When casting artificial bait such as a lure, the angler operates the handle regularly and/or irregularly to make the artificial bait move like live bait. During this winding process, the rotor moves at various speeds in accordance with the handle operation, thereby adjusting the winding speed. When a target fish hits, the angler operates the handle in accordance with the movement of the fish that hit, to rotate the rotor and wind up the line.

### SUMMARY

It has been determined that, generally an angler reflects on the fishing experience based on the catch results and prepares for the next fishing experience. If the behavior of a spinning reel during the fishing experience, that is, the operation of the spinning reel by an angler, is quantitatively recorded, an analysis of the fishing experience would be advantageous. In the prior art, spinning reels equipped with a sensor unit that measures the behavior of the spinning reel have been proposed (for example, see Japanese Patent No. 7112306).

The spinning reel disclosed in Japanese Patent No. 7112306 has a three-axis acceleration sensor and a rotary encoder that measures the rotational frequency or the rotational speed of the handle. It is thereby possible to detect rotation information and acceleration of the handle during the fishing experience so that the fishing experience can be quantitatively analyzed.

It has been determined that to analyze the fishing experience in more detail, the following types of data are generally required, data on the frequency or timings of the opening/closing of the bail during the fishing experience, and data on changes in the rotational speed of the rotor in during the fishing experience.

The embodiments of the present invention were made in light of the above-determined problem, and an object thereof is to provide a spinning reel that can acquire data relating to opening/closing of a bail or the rotation of a rotor during a fishing experience.

A spinning reel according to a first aspect of the present disclosure comprises a reel body, a spool, a rotor, a bail arm, a moving member, a detected part, and a first detecting part. A handle is attached to the reel body. The spool is provided on the reel body and a fishing line can be wound therearound. The rotor rotates relative to the reel body in accordance with rotation of the handle, and allows the fishing line to be wound onto the spool, or the fishing line to be released from the spool (e.g., during casting). The bail arm swings between a first posture in which the fishing line can be wound onto the spool by the rotation of the rotor, and a second posture in which the fishing line can be released from the spool. The moving member is in a first position when the bail arm is in the first posture, and is in a second position when the bail arm is in the second posture. When the moving member shifts from the second position to the first position, the bail arm returns from the second posture to the first posture. The detected part is provided on the moving member. The first detecting part is provided on the reel body and detects the position of the detected part.

According to this configuration, when the bail arm is in the first posture, the fishing line can be wound up. This position is commonly referred to as the bail closed posture. When the bail arm is in the second posture, the fishing line can be released (e.g., cast) from the spool. This position is commonly referred to as the bail open posture. When the bail is switched between closed and open, the moving member shifts between the first and second positions accordingly. Since the first detecting part detects the position of the moving member, at least the opening of the bail is detected. As the number of times or the frequency of opening of the bail is detected, it becomes possible to quantitatively record and analyze casting while fishing.

A spinning reel according to a second aspect of the present disclosure comprises a reel body, a spool, a rotor, a bail arm, a moving member, a detected part, and a second detecting part. A handle is attached to the reel body. The spool is provided on the reel body and a fishing line can be wound therearound. The rotor rotates relative to the reel body in accordance with the rotation of the handle, and allows the fishing line to be wound onto the spool, or the fishing to be released from the spool (e.g., cast). The bail arm is configured to swing between a first posture in which the fishing line can be wound onto the spool by the rotation of the rotor, and a second posture in which the fishing line can be released from the spool. The moving member is provided on the rotor. The moving member is in a first position when the bail arm is in the first posture, and is in a second position when the bail arm is in the second posture. When the moving member shifts from the second position to the first position, the bail arm returns from the second posture to the first posture. The detected part is provided on the moving member. The second detecting part is provided on the reel body and is configured to detect the movement speed of the detected part corresponding to the rotation of the rotor. That is, the second detecting part detects the rotation speed of the rotor.

According to this configuration, when the bail arm is in the first posture (bail closed posture), the fishing line can be wound up. When the bail arm is in the second posture (bail open posture), the fishing line can be released (e.g., cast) from the spool. When the bail is switched between closed and open, the moving member shifts between the first and second positions accordingly. The second detecting part is configured to detect the moving body. That is, the rotational speed of the rotor is detected. As a result, it is to quantitatively record and analyze operations of the spinning reel while fishing.

A spinning reel according to a third aspect of the present disclosure comprises a reel body, a spool, a rotor, a bail arm, a moving member, a detected part, a first detecting part, and a second detecting part. A handle is attached to the reel body. The spool is provided on the reel body and a fishing line can be wound therearound. The rotor rotates relative to the reel body in accordance with rotation of the handle, and allows the fishing line to be wound onto the spool, or the fishing to be released from the spool (e.g., cast). The bail arm is configured to swing between a first posture in which the fishing line can be wound onto the spool by the rotation of the rotor, and a second posture in which the fishing line can be released from the spool. The moving member is provided on the rotor. The moving member is in a first position when the bail arm is in the first posture, and is in a second position when the bail arm is in the second posture. When the moving member shifts from the second position to the first position, the bail arm returns from the second posture to the first posture. The detected part is provided on the moving member. The first detecting part is provided on the reel body and is configured to detect the position of the detected part. The second detecting part is provided on the reel body and detects the detected part corresponding to the rotation of the rotor.

According to this configuration, when the bail arm is in the first posture (bail closed posture), the fishing line can be wound up. When the bail arm is in the second posture (bail open posture), the fishing line can be released (cast) from the spool. When the bail is switched between closed and open, the moving member shifts between the first and second positions accordingly. Since the first detecting part detects the position of the moving member, at least the opening of the bail is detected. As the number of times and the frequency of the bail opening is detected, it is to quantitatively analyze casting during a fishing experience. The second detecting part detects the moving member. That is, the rotational speed of the rotor is detected. As a result, it is to quantitatively record and analyze the winding operations of the spinning reel while fishing.

In a spinning reel of a fourth aspect according to a third aspect of the present disclosure, the detected part is a magnet, and a single sensor unit includes the first detecting part and the second detecting part. The sensor unit has a plurality of magnetic sensors arranged along the circumferential direction of the rotor.

According to this configuration, a single magnet and a single sensor unit detect the number of times and frequency of the bail opening and the rotational speed of the rotor. That is, it is possible, with a simple structure, to detect the number of times and frequency of the bail opening and the rotational speed of the rotor, to record and analyze the overall operations during a fishing trip.

### BRIEF DESCRIPTION OF THE DRAWINGS

FIG. 1 is a perspective view of a spinning reel 10 according to a first embodiment.

FIG. 2 is a perspective view showing a toggle mechanism 16 and a bail flip mechanism 17 of the spinning reel 10.

FIG. 3 is a side view of a moving member 51.

FIG. 4 is a side view of a tubular part 61 of a housing 22 and the moving member 51.

FIG. 5 is a view of the tubular part 61 of the housing 22 as viewed from the front.

FIG. 6 is a functional block diagram of a detection mechanism 18.

FIG. 7 is a diagram showing the structures of a toggle mechanism 80, a bail flip mechanism 90, a cover 35, and a support body 29 according to a second embodiment.

FIG. 8 is a diagram showing the structures of the toggle mechanism 80, the bail flip mechanism 90, the cover 35, and the support body 29 according to the second embodiment.

FIG. 9 is a view of the toggle mechanism 80 and the bail flip mechanism 90 according to the second embodiment as viewed from the rearward 102 direction.

FIG. 10 is a view of the toggle mechanism 80 and the bail flip mechanism 90 according to the second embodiment as viewed from the rearward 102 direction.

FIG. 11 is an enlarged view of a moving member 92 as viewed from the rearward 102 direction.

### DETAILED DESCRIPTION

A preferred embodiment of the present disclosure will be described below, with reference to the drawings, as appropriate. It should be noted that the present embodiment is merely one aspect of a spinning reel according to the present disclosure, and it goes without saying that the embodiment may be modified without departing from the gist of the present disclosure.

### Overview and Features

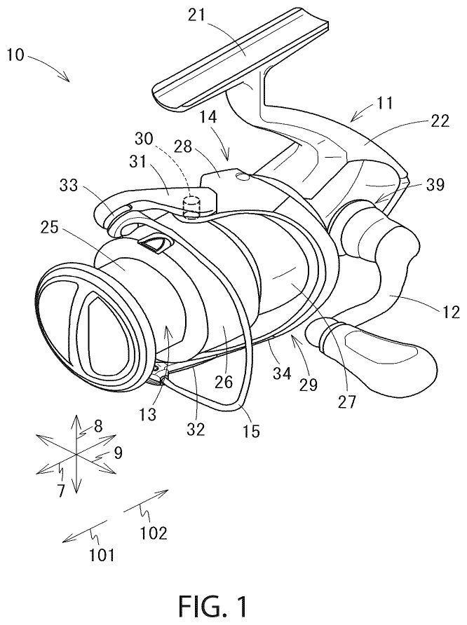

FIG. 1 is an external perspective view of a spinning reel 10 according to one embodiment of the present disclosure.

The spinning reel 10 comprises a reel body 11, a handle 12, a rotor 14, a bail 15, and a spool 13. As will be described below, the rotor 14 has a hollow structure, with a toggle mechanism 16 and a bail flip mechanism 17 built therein.

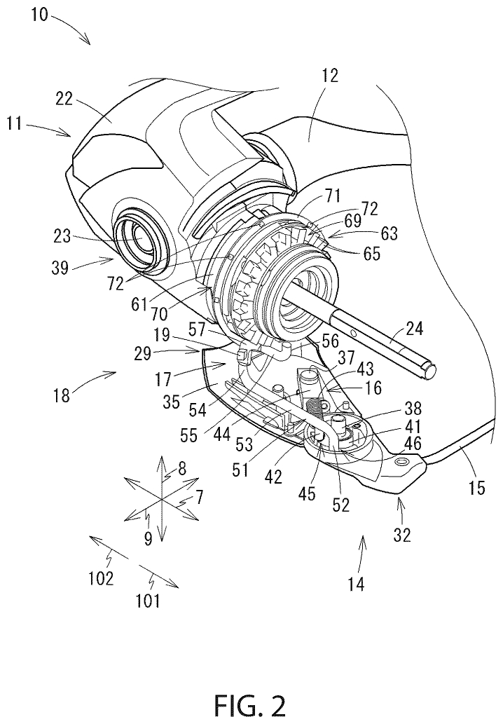

FIG. 2 is a perspective view showing the toggle mechanism 16 and the bail flip mechanism 17. This figure shows detailed structures of the toggle mechanism 16 and the bail flip mechanism 17, with the rotor 14 and the spool 13 removed.

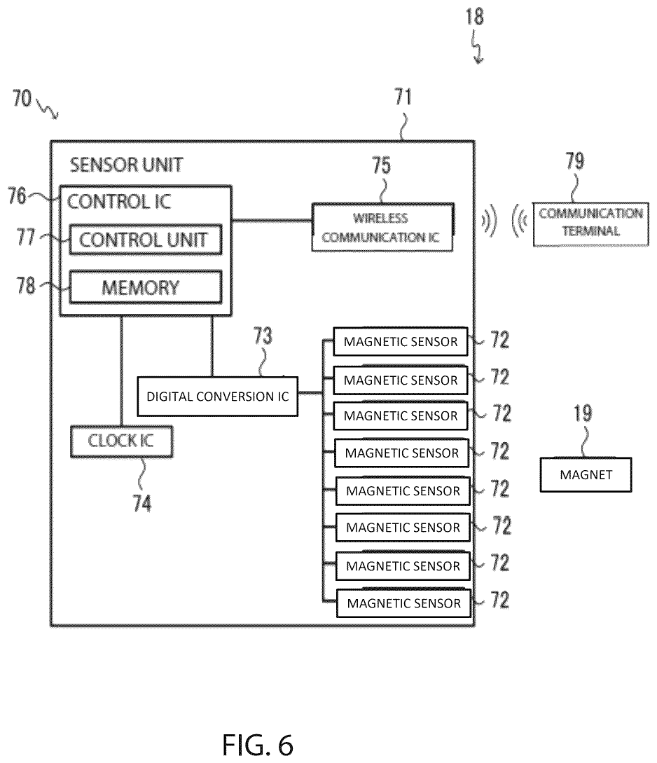

A characteristic feature of the spinning reel 10 according to the present embodiment is the detection mechanism 18 (refer to FIG. 6), described in further detail below. That is, a magnet 19 (corresponding to the “detected part” described in claims) is provided in a moving member 51 that moves with the opening/closing (swinging) of the bail 15, and a sensor unit 70 (corresponding to the “first detecting part” and the “second detecting part” described in claims) is provided in the reel body 11. The opening/closing of the bail 15 and the rotation of the rotor 14 are thereby detected, making it possible to quantitatively record and analyze actual fishing.

### Structure of Spinning Reel

The basic structure of the reel body 11 is generally known. The reel body 11 comprises the housing 22, a spool shaft 24, and first and second drive mechanisms, which are not shown. A handle 12 is attached to this reel body 11. The handle 12 has a handle shaft 23. The handle shaft 23 is inserted into the reel body 11 along a left-right direction 9, and is supported by a pair of handle attaching portions 39 so as to be rotatable. The first drive mechanism moves the spool shaft 24 in reciprocating fashion, in conjunction with the rotation of the handle shaft 23. The second drive mechanism rotates the rotor 14 in conjunction with the rotation of the handle shaft 23. Since the first and second drive mechanisms are known, descriptions thereof are omitted.

A mounting leg 21 is integrally formed with the housing 22 and is attached to fishing rod (not shown). The reel body 11 is fixed to the fishing rod via the mounting leg 21.

In FIGS. 1 and 2, the direction indicated by an arrow 101 is defined as “forward” and the direction indicated by an arrow 102 is defined as “rearward” Therefore, the direction that includes the foregoing directions is defined as the front-rear direction 7, arrow 8 in the figure is defined as the up-down direction, and arrow 9 is defined as the left-right direction.

The housing 22 has the tubular part 61 (refer to FIG. 2). The tubular part 61 is formed in the front of the housing 22, i.e., in the forward direction 101 relative to the housing. The tubular part 61 supports the rotor 14 so as to be rotatable. The handle attaching portions 39 are located rearward of the tubular part 61 (i.e., in the rearward direction 102) and are provided on the left and right side surfaces of the housing 22. Therefore, the handle 12 can be attached to either the left side or the right side of the housing 22.

The spool shaft 24 extends along the front-rear direction 7 and is disposed so as to penetrate through the center of the tubular part 61 of the housing 22. The rear portion of the spool shaft 24 is supported by the tubular part 61 and moves along the front-rear direction 7 in reciprocating fashion. The front portion of the spool shaft 24 protrudes in the forward direction 101 from the tubular part 61. The spool 13 is attached to the spool shaft 24 and moves along the front-rear direction 7 in reciprocating fashion together with the spool shaft 24.

The spool 13 has a cylindrical shape. The spool 13 has a small-diameter line winding portion 25 and a large-diameter skirt portion 26. The fishing line is held in a state of being wound around the line winding portion 25. The skirt portion 26 covers a portion of the rotor 14 and prevents intrusion of water and foreign matter into the tubular part 61.

The rotor 14 comprises a tubular body 27, a pair of support bodies 28, 29, a pair of bail arms 31, 32, and a line roller 33.

The tubular body 27 has a cylindrical shape. The center of the tubular body 27 coincides with the center of the tubular part 61 and the center of the spool shaft 24. The tubular part 61 of the housing 22 is inserted into the tubular body 27 of the rotor 14. The tubular body 27 of the rotor 14 is supported by the tubular part 61 of the housing 22 so as to be rotatable. The rotor 14 rotates relative to the reel body 11 and the spool 13 in conjunction with the rotation of the handle shaft 23.

As shown in FIG. 1, the support body 28 is integrally formed with the tubular body 27. The support body 28 rotates together with the tubular body 27. The support body 28 extends out from the rear end portion of the tubular body 27, extending along the front-rear direction 7. The distal end portion of the support body 28 faces the tubular body 27 in the radial direction of the tubular body 27. The distal end portion of the support body 28 supports a bail arm 31 so as to be pivotable. The bail arm 31 has a support shaft 30. This support shaft 30 extends along the radial direction of the tubular body 27 and is supported at the distal end portion of the support body 28 so as to be pivotable. The bail arm 31 can be pivoted about the support shaft 30 relative to the distal end portion of the support body 28.

The line roller 33 is attached to the distal end portion of the bail arm 31. The line roller 33 has a roller. The roller has a disk shape and is freely pivotable. The fishing line is passed over the circumferential surface of the roller and wound around the line winding portion 25 of the spool 13.

The support body 29 is integrally formed with the tubular body 27. The support body 29 rotates together with the tubular body 27. The support body 29 extends out from the rear end portion of the tubular body 27, extending along the front-rear direction 7. The distal end portion of the support body 29 faces the tubular body 27 in the radial direction of the tubular body 27. As shown in FIG. 2, the distal end portion of the support body 29 supports a bail arm 32 so as to be pivotable. The bail arm 32 has a support shaft 38. The axis of the support shaft 38 and the axis of the support shaft 30 coincide. The support shaft 38 extends along the radial direction of the tubular body 27 and is supported at the distal end portion of the support body 28 so as to be pivotable. The bail arm 32 can be pivoted about the support shaft 38 relative to the distal end portion of the support body 29.

The support body 29 has a hollow structure. The support body 29 has a base 34 and a cover 35. The base 34 has a box shape. The cover 35 is attached to the base 34 by screw (not shown). The toggle mechanism 16 and the bail flip mechanism 17 are built into the support body 29.

The bail 15 is semicircular or U-shaped. The bail 15 extends between the distal end portion of the bail arm 31 and the distal end portion of the bail arm 32. One end of the bail 15 is connected to the line roller 33. The other end of the bail 15 is connected to the distal end portion of the bail arm 32. The bail arms 31, 32 pivot (swing) about the support shafts 30 and 38. The bail 15 and the bail arms 31, 32 are able to pivot so as to change positions between a first posture and a second posture.

The first posture is the position shown in FIG. 1, in which the fishing line can be wound onto the spool 13. The first position is commonly referred to as the bail closed posture. The second position is a position in which the fishing line can be released from the spool 13 (e.g., during casting). The second position is commonly referred to as the bail open posture. When the rotor 14 rotates in the bail closed posture, the fishing line is guided by the line roller 33 of the bail 15 and wound onto the spool 13. When casting is carried out in the bail open posture, the fishing line is released from the spool 13. That is, the rotor 14 allows the fishing line to be wound onto the spool 13, or the fishing line to be released from the spool 13.

As shown in FIG. 2, the toggle mechanism 16 includes a pivoting member 41, a shaft 42, a coil spring 43, and a support member 44.

The pivoting member 41 is attached to the support shaft 38 of the bail arm 32. When the bail arm 32 is pivoted, the pivoting member 41 pivots about the support shaft 38. The bail 15 thereby shifts between the first posture and the second posture. The pivoting member 41 has a first fitting hole 45. The first fitting hole 45 is spaced apart from the support shaft 38. One end of the shaft 42 fits into the first fitting hole 45. When the pivoting member 41 pivots with the bail 15, the one end of the shaft 42 pivots (swings) about the support shaft 38. The one end of the shaft 42 is bent, giving the shaft 42 an L shape. The other end of the shaft 42 is inserted in the support member 44.

The support member 44 has a prismatic shape. The support member 44 is supported by the support body 29 so as to be pivotable via a support pin 37. The other end of the shaft 42 is inserted into the support member 44, and the shaft 42 can slide along the longitudinal direction of the support member 44.

The coil spring 43 fits onto the shaft 42. One end of the coil spring 43 abuts against the support member 44, and the other end of the coil spring 43 abuts against the one end of the shaft 42. Accordingly, the coil spring 43 applies an elastic biasing force in the direction of removal of the shaft 42 from the support member 44. The biased shaft 42 biases the bail arm 32 via the pivoting member 41 and the support shaft 38. The bail arm 32 and the bail 15 are biased to the first posture or the second posture. The direction of the elastic force received by the one end of the shaft 42 differs depending on the pivot position of the pivoting member 41. That is, when the pivoting member 41 is positioned on one side or the other side of a specific neutral position, the coil spring 43 biases the bail arm 32 and the bail 15 to the first posture or the second posture.

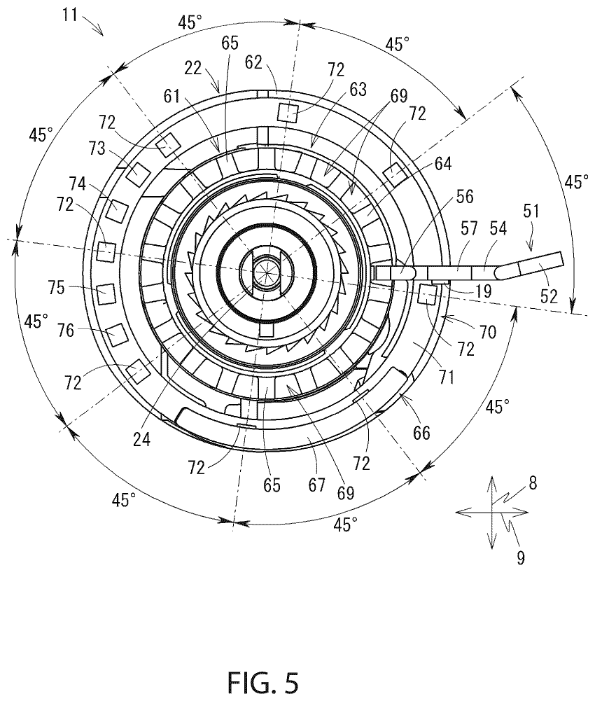

The bail flip mechanism 17 changes the position of the bail 15 in the second posture to the first posture in conjunction with the rotation of the rotor 14. That is, when the handle 12 is operated when the bail 15 is in the second posture (bail open posture), the bail 15 automatically returns from the second posture to the first posture (bail closed posture), and the fishing line is wound onto the spool 13. The bail flip mechanism 17 comprises the moving member 51, a sliding contact part 57, and a braking member 63 and a cam member 66 provided in the housing 22 (refer to FIG. 5).

The pivoting member 41 has a second fitting hole 46. The second fitting hole 46 is spaced apart from the support shaft 38. A fitting end portion 52 of the moving member 51 fits into the second fitting hole 46. When the pivoting member 41 pivots with the bail arm 32, the fitting end portion 52 of the moving member 51 pivots (swings) about the support shaft 38.

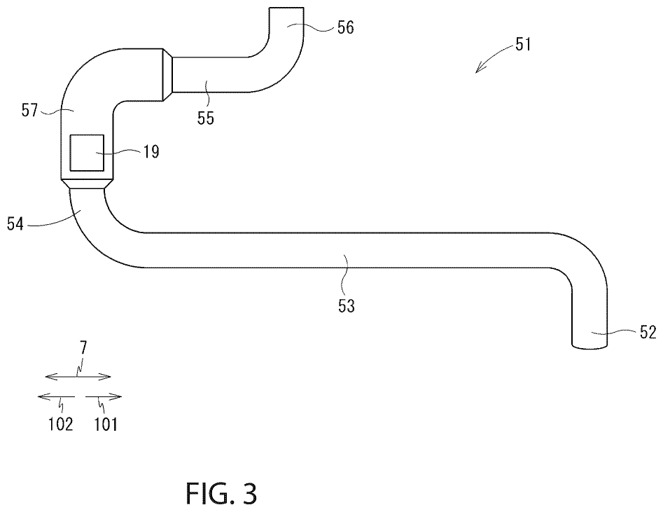

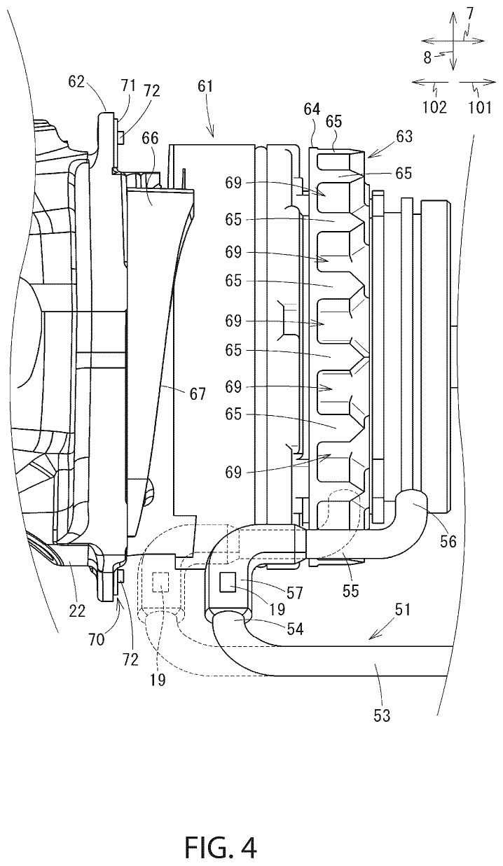

FIG. 3 is a side view of the moving member 51. FIG. 4 is a side view of the tubular part 61 of the housing 22 and the moving member 51. FIG. 4 shows the positional relationship between the moving member 51 with respect to the tubular part 61 of the housing 22 during movement. The moving member 51 indicated by the solid lines in the figure shows a case in which the bail arm 32 is in the first position. The moving member 51 indicated by broken lines in the figure shows a case in which the bail arm 32 is in the second position.

The moving member 51 is produced by bending a metal pin or wire, or by resin molding.

As shown in FIG. 3, the moving member 51 includes the fitting end portion 52, a first connecting portion 53, a sliding contact portion 54, a second connecting portion 55, and an engaging end portion 56.

As shown in FIG. 2, the fitting end portion 52 fits into the second fitting hole 46 of the pivoting member 41. The fitting end portion 52 swings in conjunction with the pivoting of the pivoting member 41. The moving member 51 moves rearward 102 when the bail arm 32 is pivoted from the first posture to the second posture. The moving member 51 moves in the forward direction 101 when the bail arm 32 is pivoted from the second posture to the first posture. The moving member 51 is in the first position indicated by the solid lines in FIG. 4 when the bail arm 32 is in the first posture. The moving member 51 is in the second position indicated by the broken lines in FIG. 4 when the bail arm 32 is in the second posture. The moving member 51 moves (shifts) between the first position and the second position in conjunction with the pivoting of the bail arm 32.

As shown in FIG. 3, the first connecting portion 53 is located in the rearward direction 102 direction of the fitting end portion 52 and extends along the front-rear direction 7. The first connecting portion 53 connects the fitting end portion 52 and the sliding contact portion 54. The front end of the first connecting portion 53 is continuous with the fitting end portion 52, and the rear end of the first connecting portion 53 is continuous with the sliding contact portion 54.

The sliding contact portion 54 is located in the rearward direction 102 of the fitting end portion 52 and is perpendicular to the first connecting portion 53. The sliding contact portion 54 has the sliding contact part 57, described later.

The second connecting portion 55 is located in the forward direction 101 of the sliding contact portion 54 and extends straight along the front-rear direction 7. The second connecting portion 55 is disposed parallel to the first connecting portion 53, and the rear end of the second connecting portion 55 is continuous with the sliding contact portion 54. The front end of the second connecting portion 55 is continuous with the engaging end portion 56.

The engaging end portion 56 is located in the rearward direction 102 of the fitting end portion 52 and in the forward direction 101 of the sliding contact portion 54. The engaging end portion 56 is disposed perpendicular to the second connecting portion 55 and parallel to the sliding contact portion 54.

As shown in FIG. 4, when the bail arm 32 is in the first posture and the moving member 51 is in the first position, the engaging end portion 56 is at a position not in contact with the braking member 63 of the housing 22. When the bail arm 32 is in the second posture and the moving member 51 is in the second position, the engaging end portion 56 is in contact with the braking member 63 of the housing 22.

The sliding contact part 57 has a rectangular tubular shape. The sliding contact part 57 is provided on the sliding contact portion 54 of the moving member 51. When the rotor 14 is rotated, the sliding contact part 57 slidingly contacts a cam surface 67 of the cam member 66 of the housing 22 and is moved relatively in the forward direction 101. The sliding contact part 57 can be omitted. In that case, the outer shape of the sliding contact portion 54 is formed so as to slidingly contact the cam surface 67 when the rotor 14 is rotated.

The braking member 63 has a ring-shaped portion 64 and a plurality of engagement projections 65. The engagement projections 65 protrude from the ring-shaped portion 64 and are arranged along the circumferential direction at equal intervals. As a result, recesses 69 are formed between adjacent engagement projections 65. The ring-shaped portion 64 is inserted in the tubular part 61 of the housing 22 and is supported so as to be rotatable relative to the tubular part 61. The inner circumferential surface of the ring-shaped portion 64 abuts against the outer circumferential surface of the tubular part 61 of the housing 22, generating a prescribed frictional force between the two elements.

When the bail arm 32 is pivoted from the first posture to the second posture, the engaging end portion 56 of the moving member 51 is fitted in the recess 69 between the two engagement projections 65 and engages the braking member 63. When the handle 12 is rotated in a state in which the bail arm 32 is in the second posture, the braking member 63 engaged with the moving member 51 rotates around the spool shaft 24. Since frictional force is generated between the rotating braking member 63 and the tubular part 61 of the housing 22, the rotation of the rotor 14 is braked. Accordingly, when the bail arm 32 is in the second posture (bail open posture), the handle 12 will not be unintentionally rotated by the angler.

The cam member 66 is fixed to the tubular part 61 of the housing 22. The cam member 66 has an arc shape extending along the peripheral edge of the tubular part 61. The height of the cam member 66 (the length in the front-rear direction 7) gradually changes along the circumferential direction. Accordingly, the cam member 66 has a wedge shape, and the front surface of the cam member 66 constitutes a cam surface 67 that is inclined in the front-rear direction 7.

When the bail 15 is in the first posture and the moving member 51 is in the first position (the state indicated by the solid lines in FIG. 4), the cam surface 67 is spaced apart from the sliding contact part 57 of the moving member 51. When the bail 15 is in the second posture and the moving member 51 is in the second position (the state indicated by the dotted lines in FIG. 4), the cam surface 67 abuts against the sliding contact part 57 of the moving member 51. When the handle 12 is rotated in a state in which the bail 15 is in the second posture, the sliding contact part 57 of the moving member 51 comes into sliding contact with the cam surface 67 and is pushed in the forward direction 101. When the moving member 51 is moved in the forward direction 101, the pivoting member 41 (refer to FIG. 2) pivots, and the bail 15 returns to the first posture via the toggle mechanism 16 and the bail flip mechanism 17.

### Detection Mechanism

FIG. 5 is a view of the tubular part 61 of the housing 22 as viewed from the forward direction 101. FIG. 5 is a diagram explaining the arrangement of the sensor unit 70. FIG. 6 is a functional block diagram of a detection mechanism 18.

The spinning reel 10 comprises the detection mechanism 18 shown in FIG. 6. The detection mechanism 18 detects the pivot position of the bail 15 and the rotation of the rotor 14. Detecting the pivot position of the bail 15 means detecting whether the bail 15 is in the first posture or the second posture. Detecting the rotation of the rotor 14 means detecting whether the rotor 14 is rotating, and detecting the rotational speed if the rotor 14 is rotating.

The detection mechanism 18 includes the magnet 19 attached to the moving member 51, and the sensor unit 70 that detects the magnetism formed by the magnet 19.

As shown in FIGS. 4 and 5, the magnet 19 is attached to the sliding contact part 57 of the moving member 51. The magnet 19 rotates in conjunction with the rotation of the rotor 14 and moves along the front-rear direction 7 in conjunction with the pivoting of the bail 15.

The magnet 19 is cuboid. The magnet 19 is fixed to the sliding contact part 57 by an adhesive, for example.

A flange 62 is formed on the tubular part 61 of the housing 22 (refer to FIGS. 4 and 5). The flange 62 is disposed in the rearward 102 direction of the cam member 66, that is, in the rearward 102 direction of the sliding contact part 57 of the moving member 51. The magnet 19 attached to the sliding contact part 57 faces a portion of the flange 62 in the front-rear direction 7.

As shown in FIGS. 5 and 6, the sensor unit 70 is attached to the front surface of the flange 62. The sensor unit 70 is not linked to the rotation of the rotor 14 or the pivoting of the bail 15. The sensor unit 70 includes a substrate 71, a plurality of magnetic sensors 72, a digital conversion IC 73, a clock IC 74, a wireless communication IC 75, and a control IC 76. The plurality of magnetic sensors 72, the digital conversion IC 73, the clock IC 74, the wireless communication IC 75, and the control IC 76 are electrically connected by patterns on the substrate 71.

The substrate 71 is formed in an annular shape and is fixed to the front surface of the flange 62 by an adhesive, for example.

The magnetic sensors 72 are mounted on the substrate 71. The plurality of magnetic sensors 72 are arranged spaced apart from each other at equal intervals along the circumferential direction. In the present embodiment, eight magnetic sensors 72 are arranged spaced apart from each other at intervals of 45 degrees. Each of the magnetic sensors 72 has a detection coil and outputs a detected value corresponding to changes in the magnetic intensity (changes in magnetic flux) caused by the movement of the magnet 19 located in the forward 101 direction.

The digital conversion IC 73 is mounted on the substrate 71. The digital conversion IC 73 converts the analog detection signal output by the magnetic sensors 72 to a digital signal and outputs the same. If the magnetic sensors 72 output a digital signal, the digital conversion IC 73 is omitted.

The clock IC 74 is mounted on the substrate 71. The clock IC 74 outputs date and time information.

The wireless communication IC 75 is mounted on the substrate 71. The wireless communication IC 75 carries out short-range wireless communication with a communication terminal 79 carried by the angler.

The control IC 76 is mounted on the substrate 71. The control IC 76 has a control unit (electronic controller) 77 and memory 78. The control unit 77 is, for example, a microcomputer and is not a human being. The control IC 76 determines the posture of the bail 15 on the basis of the input digital signal and calculates the rotational speed of the rotor 14. The control IC 76 stores, in the memory 78 as fishing trip information, the posture of the bail 15 and the rotational speed of the rotor 14 that have been determined, in association with the date and time information. The control IC 76 transmits the fishing trip information stored in the memory 78 to the communication terminal 79 of the angler.

The determination of the posture of the bail 15 and the calculation of the rotational speed of the rotor 14 by the control IC 76 will be described.

When the posture of the bail 15 changes, of the plurality of magnetic sensors 72, the magnetic sensor 72 that detects the change in the magnetic intensity is generally only the magnetic sensor 72 that is located rearward 102 of the magnet 19. On the other hand, when the rotor 14 rotates, the plurality of magnetic sensors 72 output approximately the same detected values (output waveform). When any one of the magnetic sensors 72 detects a change in the magnetic intensity, the control IC 76 compares the difference between the detected value of this magnetic sensor 72 and the detected values of the other magnetic sensors 72, with a threshold value stored in the memory 78. If the difference between the detected value of the magnetic sensor 72 and the detected values of the other magnetic sensors 72 is greater than or equal to the threshold value, the control IC 76 determines that the postures of the bail 15 and the bail arm 32 have changed, and if the difference is less than the threshold value, the control IC 76 determines that the rotor 14 is rotating.

When the rotor 14 is rotating, the signals input from the magnetic sensors 72 to the control IC 76 form periodic square waves. When determining that the rotor 14 is rotating, the control IC 76 counts the number of square waves input during a prescribed period of time. The prescribed period of time is a so-called sampling period, and is several milliseconds to several hundred milliseconds. The count number, which is the number of the square waves that have been counted, is a value corresponding to the rotational speed of the rotor 14. The control IC 76 stores the value corresponding to the count number in the memory 78 as the rotational speed of the rotor 14, in association with the date and time information. That is, the sensor unit 70 detects the movement speed of the magnet 19 corresponding to the rotation of the rotor 14.

The rotor 14 is rotated when the bail 15 is in the first posture. For example, the control IC 76 determines a position change immediately before rotation of the rotor 14 to be a position change from the second posture to the first posture. The control IC 76 determines a position change immediately after rotation of the rotor 14 to be a position change from the first posture to the second posture.

The control IC 76 acquires detected values of the magnetic sensors 72 at a prescribed sampling period, and stores, in the memory 78, a position flag of either “0” or “1” and the rotational speed. A position flag of “0” indicates a position change from the first posture to the second posture and a position flag of “1” indicates a position change from the second posture to the first posture.

The control IC 76 transmits the position flag and the rotational speed associated with the date and time information as fishing trip information to the communication terminal 79 of the angler via the wireless communication IC 75. 4. Operation of the spinning reel 10

The angler changes the position of the bail 15 that is in the first posture (bail closed posture) to the second posture (bail open posture) and casts. During casting, the bail 15 is maintained in the second posture by the toggle mechanism 16. The detection mechanism 18 detects presence/absence of position change of the bail 15 for each sampling period.

After casting, the angler changes the position of the bail 15 from the second posture to the first posture and rotates the handle 12 to wind the fishing line. Alternatively, if the angler rotates the handle 12 without changing the position of the bail 15 from the second posture to the first posture, the bail 15 changes position from the second posture to the first posture via the bail flip mechanism 17. The detection mechanism 18 detects the position change of the bail 15 from the second posture to the first posture and the rotational speed of the rotor 14.

The sensor unit 70 transmits, to the communication terminal 79 of the angler, fishing trip information including position changes of the bail 15 and the rotational speed of the rotor 14 that have been detected.

### Action and Effects of the First Embodiment

As shown in FIGS. 2 and 4, the magnet 19 is attached to the moving member 51, and this moving member 51 moves in the front-rear direction 7 in conjunction with changes in the positions of the bail 15 and the bail arm 32. On the other hand, a plurality of the magnetic sensors 72 are arranged in the rearward direction 102 of the magnet 19 and spaced apart from each other at equal intervals. Accordingly, regardless of what rotational position the rotor 14 stops at, one of the magnetic sensors 72 will be positioned within a detectable range rearward 102 of the magnet 19. As a result, the sensor unit 70 can detect a position change of the bail 15 (bail open/bail close) regardless of the stopped position of the rotor 14. By detecting the number of times and the frequency of the bail opening and closing, it is possible to quantitatively analyze casting during a fishing experience.

As shown in FIG. 4, the magnet 19 rotates while facing the front surface of the annular substrate 71. The plurality of magnetic sensors 72 are aligned along the circumferential direction of the substrate 71. Accordingly, the sensor unit 70 can detect the rotational speed of the rotor 14 based on the number of changes in the magnetic intensity detected by the magnetic sensors 72. As a result, it is possible to quantitatively analyze fishing line winding operations of the spinning reel 10 during a fishing operation.

Since the sensor unit 70 can detect both a change in the position of the bail 15 and the rotational speed of the rotor 14, it is possible to carry out a more detailed quantitative analysis of casting in during a fishing operation compared to when only one of position change and rotational speed is detected.

As shown in FIG. 5, since a plurality of the magnetic sensors 72 are arranged at equal intervals, the accuracy of detecting the rotational speed is improved compared to when the rotational speed of the rotor 14 is detected by one magnetic sensor.

### Modified Example of the First Embodiment

In the spinning reel 10 according to the first embodiment, the magnet 19 is attached to the sliding contact part 57, but no limitation is imposed thereby. The magnet 19 can be attached to the first connecting portion 53, the sliding contact portion 54, or the second connecting portion 55 of the moving member 51. The magnet 19 can be attached to any part of the moving member 51 as long as the magnet 19 can move along the front-rear direction 7 in conjunction with the moving member 51.

### Second Embodiment

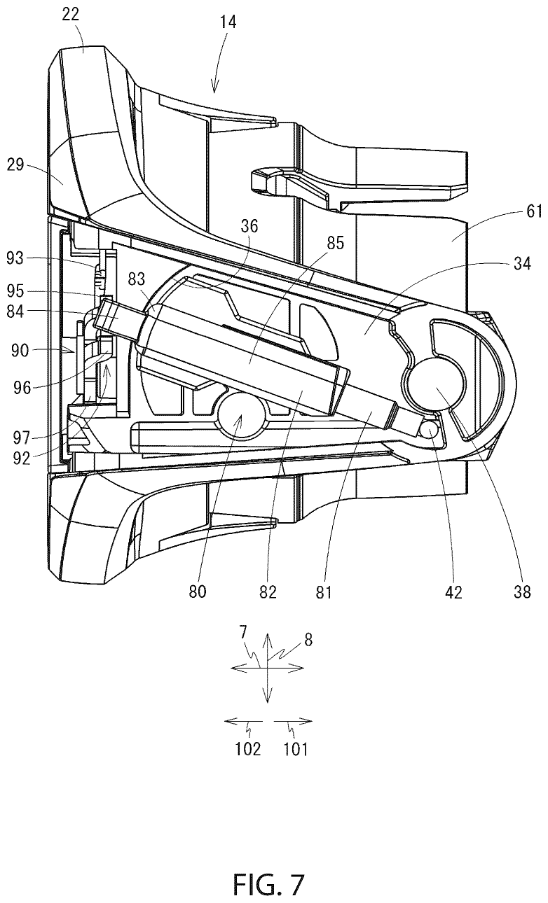

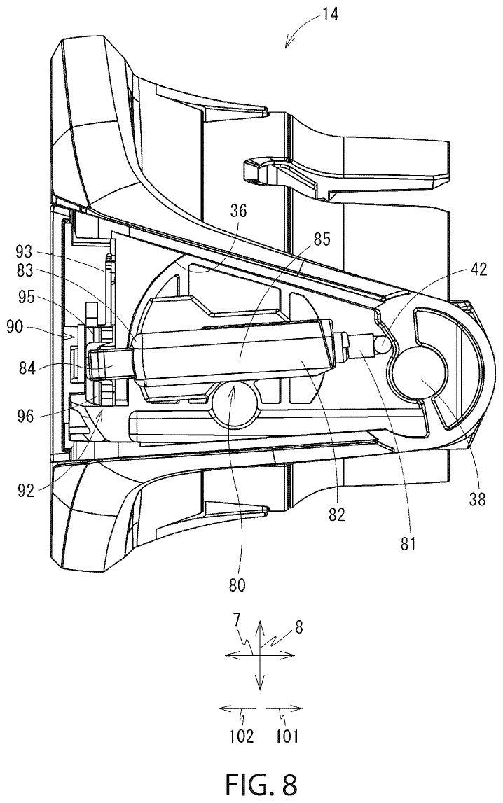

FIGS. 7 and 8 show the structures of a toggle mechanism 80, a bail flip mechanism 90, a cover 35, and a support body 29 according to the second embodiment. FIG. 7 shows a state in which the bail 15 is in the first posture. FIG. 8 shows a state in which the bail 15 is in the second posture. FIGS. 7 and 8 show states in which the pivoting member 41 and the tubular body 27 of the rotor 14 have been removed.

The toggle mechanism 80 and the bail flip mechanism 90 of the spinning reel 10 according to the second embodiment are shown in FIG. 7. The toggle mechanism 80 and the bail flip mechanism 90 are different from the toggle mechanism 16 and the bail flip mechanism 17 of the spinning reel 10 according to the first embodiment shown in FIG. 2. In the spinning reel 10 according to the second embodiment, configurations that are the same as those of the first embodiment have been assigned the same codes, and descriptions thereof will be omitted.

As shown in FIGS. 7 and 8, the toggle mechanism 80 and the bail flip mechanism 90 are arranged inside the support body 29.

The toggle mechanism 80 comprises an outer tubular member 82, the shaft 42, a spring member 81, and a pivoting member 41 (refer to FIG. 2).

Typically, the spring member 81 is a tubular coil spring. The shaft 42 is inserted into the spring member 81, which are both fitted into the outer tubular member 82. The outer tubular member 82 is provided with a protrusion 84 at an end 83 thereof. The protrusion 84 engages with the moving member 92 of the bail flip mechanism 90. One end of the shaft 42 is connected to the pivoting member 41.

A central portion 85 of the outer tubular member 82 is supported by the base 34 of the support body 29 so as to be pivotable, and the outer tubular member 82 swings about the central portion 85. The base 34 has a guide surface 36. The end 83 of the outer tubular member 82 is in contact with the guide surface 36, and the outer tubular member 82 swings while the end 83 is guided by the guide surface 36. In the same manner as in the first embodiment, since the shaft 42 is elastically biased by the spring member 81, the toggle mechanism 80 is biased to the position shown in FIG. 7, or biased to the position shown in FIG. 8, with a prescribed neutral position serving as a boundary.

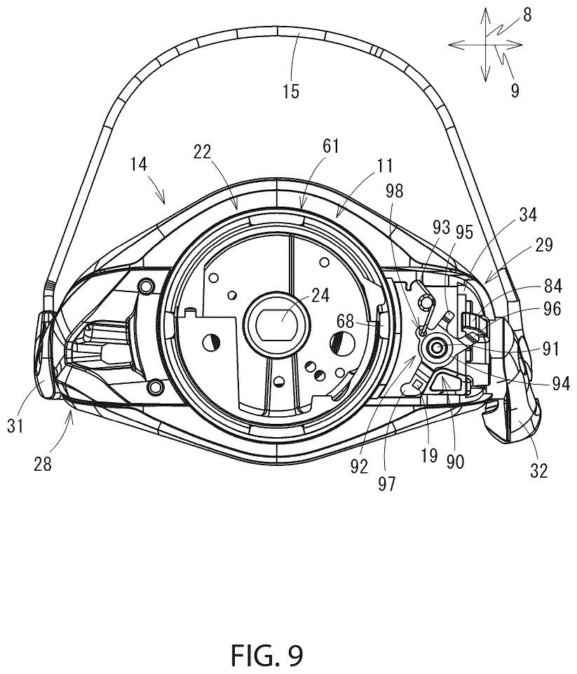

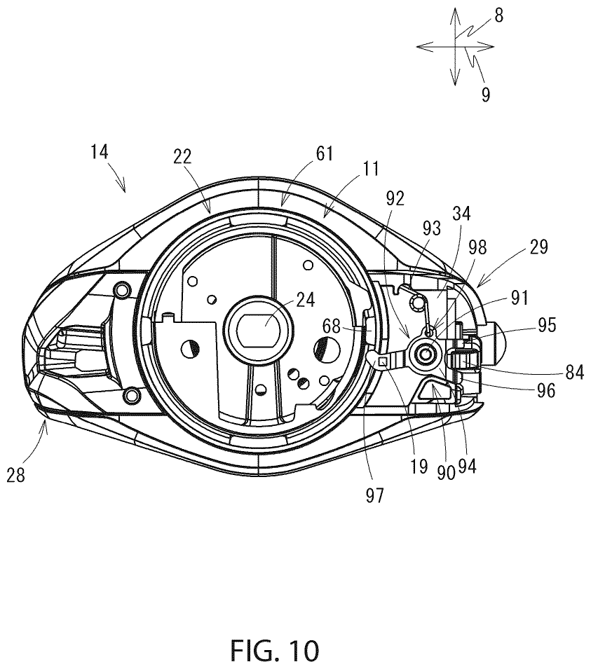

FIGS. 9 and 10 are views of the toggle mechanism 80 and the bail flip mechanism 90 according to the second embodiment as viewed from the rearward direction 102 direction. FIG. 9 shows a state in which the bail 15 and the bail arm 32 are in the first posture. FIG. 10 shows a state in which the bail 15 and the bail arm 32 are in the second posture. In FIG. 10, the bail 15 and the bail arm 32 are not shown.

The bail flip mechanism 90 includes a pivot shaft 91, the moving member 92, and a torsion coil spring 93.

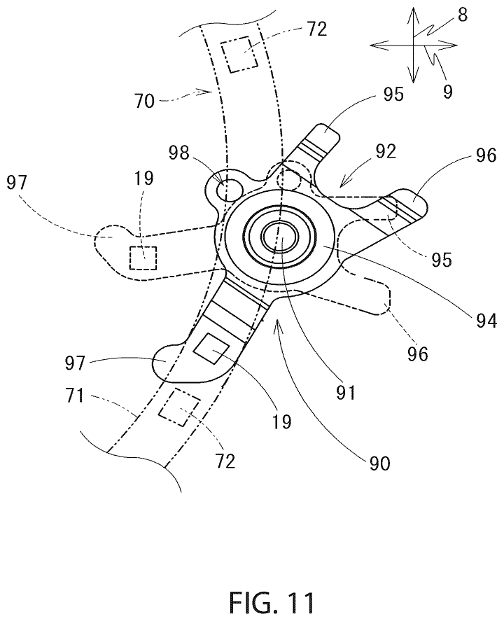

FIG. 11 is an enlarged view of the moving member 92 as viewed from the rearward 102 direction. In the figure, a part of the sensor unit 70 is also shown by chain double-dashed lines. The moving member 92 indicated by the solid lines in the figure shows a case in which the bail arm 32 is in the first posture. The moving member 92 indicated by broken lines in the figure shows a case in which the bail arm 32 is in the second posture. The figure also shows the positional relationship between the movement of the moving member 92 and the sensor unit 70 and magnetic sensors 72.

The pivot shaft 91 is provided on the support body 29 and extends in the front-rear direction 7. The moving member 92 is supported on the pivot shaft 91 so as to be pivotable.

The moving member 92 has a disc portion 94, a pair of engagement projections 95, 96, and a lock pawl 97.

The engagement projections 95, 96 protrude radially outward from the circumferential surface of the disc portion 94. The engagement projection 95 and the engagement projection 96 are spaced apart from each other in the circumferential direction of the disc portion 94. The protrusion 84 of the outer tubular member 82 is fitted between the engagement projection 95 and the engagement projection 96. When the outer tubular member 82 pivots, the moving member 92 pivots in conjunction therewith. That is, in the present embodiment, when the bail 15 is pivoted, the pivoting member 41 (refer to FIG. 2) pivots, and the moving member 92 pivots about the pivot shaft 91 via the shaft 42 and the outer tubular member 82.

When the bail arm 32 is in the first posture (bail closed posture: refer to FIG. 7), the moving member 92 is in the first position shown in FIG. 9. On the other hand, when the bail arm 32 is in the second posture (bail open posture: refer to FIG. 8), the moving member 92 is in the second position shown in FIG. 10. The moving member 92 moves (shifts) between the first position and the second position in conjunction with the pivoting of the bail arm 32.

An engagement hole 98 is provided at the peripheral edge of the disc portion 94. One end of the torsion coil spring 93 is fitted into the engagement hole 98 and the other end of the torsion coil spring 93 is attached to the base 34 of the support body 29. Accordingly, the moving member 92 is biased by the elastic force of the torsion coil spring 93 in a direction from the second position toward the first position, with the pivot shaft 91 serving as the fulcrum.

The lock pawl 97 protrudes outward from the peripheral edge of the disc portion 94. When the moving member 92 pivots from the first position to the second position, the lock pawl 97 moves in a direction approaching the center of the rotor 14 (center of the spool shaft 24). On the other hand, when the moving member 92 pivots from the second position to the first position, the lock pawl 97 moves in a direction away from the center of the rotor 14.

A stopper 68 is formed on the tubular part 61 of the housing 22. When the lock pawl 97 is in the first position, the lock pawl 97 does not abut against the stopper 68. When the lock pawl 97 shifts to the second position, the lock pawl 97 abuts against the stopper 68.

When the handle 12 is rotated when the bail 15 is in the second posture (refer to FIG. 10), the stopper 68 abuts against the lock pawl 97 and the rotation of the handle 12 and the rotor 14 is restricted. When the handle 12 is rotated at a force exceeding the biasing force of the torsion coil spring 93, the moving member 92 and the lock pawl 97 abutting against the stopper 68 shift from the second position to the first position. As a result, the outer tubular member 82 of the toggle mechanism 80 is pivoted and the bail 15 and the bail arm 32 shift to the first posture.

In the present embodiment, the magnet 19 of the detection mechanism 18 is attached to the lock pawl 97 using an adhesive, or the like. When the bail arm 32 shifts between the first posture and the second posture, the magnet 19 moves in a direction approaching the center of the rotor 14 or in a direction away from the center of the rotor 14. The magnet 19 of the detection mechanism 18 can be provided on the disc portion 94 of the moving member 91, for example at a peripheral edge of the disc portion 94 in the vicinity of the engagement hole 98.

As shown in FIG. 11, a portion of the substrate 71 of the sensor unit 70 is located rearward 102 of the lock pawl 97 (solid lines) in the first position. Accordingly, one of the plurality of magnetic sensors 72 mounted on the substrate 71 is located rearward 102 of the magnet 19 attached to the lock pawl 97, regardless of the position at which the rotor 14 is stopped. That is, at least one of the magnetic sensors 72 can detect a position change of the bail 15 regardless of the stopped position of the rotor 14.

When the bail arm 32 shifts from the first posture to the second posture, the magnet 19 moves toward the center of the tubular body 27 of the rotor 14 and away from the magnetic sensors 72 (dotted lines). When the magnet 19 moves away from the magnetic sensors 72, a change in the magnetic intensity (change in the magnetic flux) occurs. The magnetic sensors 72 detect the change in the magnetic intensity that occurs as a result of the magnet 19 moving away.

When the bail arm 32 shifts from the second posture to the first posture, the magnet 19 moves in a direction away from the center of the rotor 14 and approaches the magnetic sensors 72. When the magnet 19 approaches the magnetic sensors 72, a change in the magnetic intensity occurs. The magnetic sensors 72 detect the change in the magnetic intensity that occurs as a result of the approach of the magnet 19.

As shown in FIG. 6, the control IC 76 determines the position of the bail 15 and calculates the rotational speed of the rotor 14 in the same manner as in the first embodiment, on the basis of detected values input from the magnetic sensors 72. The control IC 76 stores in the memory 78, and transmits to the communication terminal 79 of the angler, the rotational speed and the position flag indicating the position of the bail 15 that have been determined.

### Action and Effects of the Second Embodiment

As shown in FIGS. 9 and 10, the magnet 19 is attached to the lock pawl 97, and the lock pawl 97 moves along the radial direction of the rotor 14 in conjunction with position changes of the bail 15 and the bail arm 32. On the other hand, as shown in FIG. 11, a plurality of the magnetic sensors 72 are arranged in the rearward direction 102 of the magnet 19 at equal intervals. Accordingly, regardless of what rotational position the rotor 14 stops at, one of the magnetic sensors 72 will detect the magnet 19. That is, the sensor unit 70 can detect a position change of the bail 15 (bail open/bail close). As a result, the number of times and the frequency of the bail opening and closing are detected, and it is possible to quantitatively analyze casting in actual fishing.

As the rotor 14 rotates, the magnet 19 rotates while facing the front surface of the annular substrate 71. The plurality of magnetic sensors 72 are aligned along the circumferential direction of the annular substrate 71. Accordingly, the sensor unit 70 can measure the rotational speed of the rotor 14 based on the number of changes in the magnetic intensity detected by the magnetic sensors 72. As a result, it is possible to quantitatively analyze fishing line winding operations during a fishing experience.

Since the sensor unit 70 can detect both a change in the position of the bail 15 and the rotational speed of the rotor 14, it is possible to carry out a more detailed quantitative analysis of casting during a fishing experience compared to when only one of position change and rotational speed is detected.

### Modified Examples of the First and Second Embodiments

In the first and second embodiments, the sensor unit 70 has the plurality of magnetic sensors 72, which are arranged along the circumferential direction of the tubular body 27 of the rotor 14. However, the sensor unit 70 can be equipped with an annular magnetic sensor instead of the plurality of magnetic sensors 72 arranged in the manner described above. An annular magnetic sensor is a so-called magnetic rotary encoder. Even when an annular magnetic sensor is used, the sensor unit 70 can detect the rotational speed of the rotor 14 and the position of the bail 15 in the same manner as when using the plurality of magnetic sensors 72.

The control IC 76 can add a specific flag to the fishing trip information. The specific flag indicates whether the handle 12 was rotated while the bail 15 was still in the second posture (bail open posture), or whether the handle 12 was rotated after the position of the bail 15 changed from the second posture to the first posture (bail closed posture). If the handle 12 was rotated while the bail 15 was still in the second posture, the rotor 14 can rotate in a state in which a prescribed braking force is applied thereto by the braking member 63. When the control IC 76 detects rotation of the rotor 14 immediately after determining that the bail 15 is in the second posture, and the detected rotational speed of the rotor 14 is less than or equal to a threshold speed, the control IC 76 determines that the handle 12 was rotated while the bail 15 was still in the second posture. The control IC 76 stores, in the memory 78, a specific flag indicating whether the handle 12 was rotated while the bail 15 was still in the second posture, in association with the date and time information.

In the first and second embodiments, the control IC 76 stores, in the memory 78, a position flag indicating the position of the bail 15. Alternatively, the control IC 76 may store, in the memory 78, a position change flag instead of a position flag in association with the date and time information. The position change flag is, for example, a value of “0” indicating that the position of the bail 15 has changed from the first posture to the second posture or a value of “1” indicating that the position of the bail 15 has changed from the second posture to the first posture.

In the first and second embodiments, the sensor unit 70 detects both the position of the bail 15 and the rotational speed of the rotor 14. However, the sensor unit 70 may detect only position changes of the bail 15 or only the rotational speed of the rotor 14.

In the first and second embodiments, the sensor unit 70 comprises the control IC 76 and the clock IC 74. However, the control IC 76 and the clock IC 74 can be omitted from the sensor unit 70. In that case, an application program is installed in the communication terminal 79 of the angler. The sensor unit 70 outputs, to the communication terminal 79, data which are the detected values input from the magnetic sensors 72. Instead of the control IC 76, the application program executes the process that is executed by the control IC 76. That is, the application program determines the position of the bail 15 and the rotational speed of the rotor 14 on the basis of the received data, and stores the same in the memory 78 of the communication terminal 79 in association with the date and time information.

In the first and second embodiments, the detection mechanism 18 is provided with the magnet 19 and the magnetic sensors 72. However, the detection mechanism 18 may be provided with a metal body instead of the magnet 19 (corresponding to the “detected part” described in claims) and a plurality of proximity sensors instead of the plurality of magnetic sensors 72. The metal body is, for example, a piece of iron, and is disposed at the same location as the magnet 19. The proximity sensors are provided in the same positions as the magnetic sensors 72, and are mounted on the substrate 71. The proximity sensors generate a high-frequency magnetic field. The proximity sensors detect and output changes in the magnetic field (changes in the magnetic flux) caused by the metal body. Even when using a metal body and proximity sensors, the detection mechanism 18 can detect the position of the bail 15 and the rotational speed of the rotor 14.

In the first and second embodiments, the magnetic sensors 72 detect changes in the magnetic intensity. However, a type of magnetic sensor 72 that detects the magnetic intensity may be used.

The sensor unit 70 can detect reverse rotation of the rotor 14, and the rotational speed of the rotor 14 during reverse rotation. Reverse rotation of the rotor 14 means a rotation in the opposite direction to the rotational direction (forward rotation) for winding the fishing line onto the spool 13. For example, in a spinning reel provided with a so-called lever brake, an angler operates the lever brake to intentionally cause reverse rotation of the rotor 14.

In this case, the plurality of magnetic sensors 72 are individually identified using an identification ID. The order of the magnetic sensors 72 that detect changes in the magnetic intensity differs between forward rotation and reverse rotation. The control IC 76 acquires, from the identification IDs, the order of the magnetic sensors 72 that detected a change in the magnetic intensity, and determines whether the rotation of the rotor 14 is forward rotation or reverse rotation. The control IC 76 stores, in the memory 78, a rotational direction flag of “0” indicating a forward rotation or a rotational direction flag of “1” indicating a reverse rotation, in association with the rotational speed.

The control IC 76 transmits the rotational direction flag and the rotational speed to the communication terminal 79 of the angler. When it is possible to detect both forward and reverse rotations of the rotor 14, it becomes possible to quantitatively record and analyze not only casting but also reeling, in fishing that uses a spinning reel equipped with a lever brake (typically, surf fishing).

What is claimed is:

1. A spinning reel, comprising:
a handle;
a reel body to which the handle is attached;
a spool on the reel body, the spool configured to have a fishing line wound therearound;
a rotor configured to rotate relative to the reel body in accordance with rotation of the handle, and configured to wind the fishing line onto the spool, or configured to enable the fishing line to be released from the spool;
a bail arm configured to pivot between a first posture in which the fishing line is capable of being wound onto the spool by rotation of the rotor, and a second posture in which the fishing line is configured to be released from the spool;
a moving member positioned at a first position when the bail arm is in the first posture of the bail arm, is positioned at a second position when the bail arm is in the second posture of the bail arm, and configured to return the bail arm from the second posture of the bail arm to the first posture of the bail arm by shifting from the second position of the moving member to the first position of the moving member;
a detected part provided on the moving member; and
a first detecting part on the reel body and configured to detect a position of the detected part.

2. A spinning reel, comprising:
a handle;
a reel body to which the handle is attached;
a spool on the reel body, the spool configured to have a fishing line wound therearound;
a rotor configured to rotate relative to the reel body in accordance with rotation of the handle, and configured to wind the fishing line onto the spool, or configured to enable the fishing line to be released from the spool;
a bail arm configured to pivot between a first posture in which the fishing line is capable of being wound onto the spool by rotation of the rotor, and a second posture in which the fishing line is configured to be released from the spool;
a moving member positioned at a first position when the bail arm is in the first posture of the bail arm, is positioned at a second position when the bail arm is in the second posture of the bail arm, and configured to return the bail arm from the second posture of the bail arm to the first posture of the bail arm by shifting from the second position of the moving member to the first position of the moving member;
a detected part provided on the moving member; and
a second detecting part provided on the reel body and configured to detect a movement speed of the detected part corresponding to the rotation of the rotor.

3. A spinning reel, comprising:
a handle;
a reel body to which the handle is attached;
a spool on the reel body, the spool configured to have a fishing line wound therearound;
a rotor configured to rotate relative to the reel body in accordance with rotation of the handle, and configured to wind the fishing line onto the spool, or configured to enable the fishing line to be released from the spool;
a bail arm configured to pivot between a first posture in which the fishing line is capable of being wound onto the spool by rotation of the rotor, and a second posture in which the fishing line is configured to be released from the spool;
a moving member positioned at a first position when the bail arm is in the first posture of the bail arm, is positioned at a second position when the bail arm is in the second posture of the bail arm, and configured to return the bail arm from the second posture of the bail arm to the first posture of the bail arm by shifting from the second position of the moving member to the first position of the moving member;
a detected part provided on the moving member;
a first detecting part on the reel body and configured to detect the position of the moving member; and
a second detecting part on the reel body and configured to detect a movement speed of the detected part corresponding to the rotation of the rotor.

4. The spinning reel according to claim 3, wherein
the detected part is a magnet,
a single sensor unit includes the first detecting part and the second detecting part, and
the sensor unit has a plurality of magnetic sensors arranged along a circumferential direction of the rotor.
